(19) United States
(12) Patent Application Publication
(10) Pub. No.: US 2022/0095784 A1
(43) Pub. Date: Mar. 31, 2022

(54) TIRE TABLE STRUCTURE

(71) Applicant: FORMOSA SAINT JOSE CORPORATION, Taipei (TW)

(72) Inventor: Ming-Shun Yang, Taipei (TW)

(73) Assignee: FORMOSA SAINT JOSE CORP., Taipei (TW)

(21) Appl. No.: 17/038,324

(22) Filed: Sep. 30, 2020

(51) Int. Cl. A47B 3/091; A47B 3/10; A47B 5/02; A47B 37/00

(52) U.S. Cl. CPC A47B 3/0912; A47B 3/10; A47B 2003/0824; A47B 37/00; A47B 5/02

(57) ABSTRACT

The present invention discloses a tire table structure used to removably set firmly on a tire of a vehicle. The tire table structure includes a desktop unit for placing at least one object; two fixing rods each being connected to a first side of the desktop unit by a first joint unit; an U shaped rod connected at each end by a second joint unit to one fixing rod wherein each of the two ends of the U shaped rod being respectively connected to a different fixing rod; and at least one foot rod connected to a second side opposite to the first side of the desktop unit by a third joint unit. With the implementation of the present invention, the tire table structure has the special benefit of being easy to set up or operate; being able to firmly set on a tire of a vehicle; applying to all vehicle types; and more importantly, being able to fold the fixing rods, the U shaped rod and the foot rod separately at the first joint unit, the second joint unit or the third joint unit for convenient storage or transportations.

### BACKGROUND OF THE INVENTION

### 1. Technical Field

The present invention relates to a table structure, and more particularly, to a foldable tire table structure that is easy for storage and operation, and contains at least one U shaped rod and two fixing rods.

### 2. Description of Related Art

As cars are being in wide use nowadays for leisure activities or recreations, consumers' demands for a temporary desk or table for placing accessories, clothing, or even foods and drinks are continuously increasing. Convenient attachment tables or desks, or more specifically tire tables are thus come to being.

While the tire tables used on cars nowadays are mostly simple attachments to a tire and are either lacking structure stability in using that causes objects turning over or even damaged, or being inconvenient or not easy to store before or after using them. All those disadvantages generally lead to poor willingness to use on the user side, and eventually slow down the development of the relating industry.

That results in the needs for an innovation and improvement by inventing a new tire table with suitable rods and joint units, that not only applies to almost all kinds of cars, but also firmly attaches to a tire and stands firmly on the ground to provide a stable temporary table or desk for objects placement, and is easy to fold for convenient storage or transportation after usage.

### SUMMARY OF THE INVENTION

The present invention discloses a tire table structure used to removably set firmly on a tire of a vehicle. The tire table structure includes a desktop unit for placing at least one object on; two fixing rods each being connected to a first side of the desktop unit by a first joint unit; an U shaped rod connected at each end by a second joint unit to one fixing rod wherein each of the two ends of the U shaped rod being connected to different fixing rod; and at least one foot rod connected to a second side opposite to the first side of the desktop unit by a third joint unit. With the implementation of the present invention, the tire table structure has the special benefit of being easy to set up or operate; being able to firmly set on a tire of a vehicle; applying to all vehicle types; and more importantly, being able to fold the fixing rods, the U shaped rod and the foot rod at the first joint unit, the second joint unit or the third joint unit for convenient storage or transportations.

The present invention provides a tire table structure, used to removably set firmly on a tire of a vehicle, comprising: a desktop unit, for placing at least one object; two fixing rods, each being connected to a first side of the desktop unit by a first joint unit; an U shaped rod, being connected at each end by a second joint unit to one fixing rod wherein each of the two ends of the U shaped rod being respectively connected to a different fixing rod; and at least one foot rod connected to a second side opposite to the first side of the desktop unit by a third joint unit.

Implementation of the present invention at least involves the following inventive steps:

1. Being easy to set up or operate.

2. Being able to firmly set on a tire of a vehicle.

3. Applying to all vehicle types.

4. Being able to fold the fixing rods, the U shaped rod and the foot rod separately at the first joint unit, the second joint unit or the third joint unit for convenient storage or transportations.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic three-dimensional view of a tire table structure according to an embodiment of the present invention.

FIG. 2 is a schematic side view of a tire table structure wherein the fixing rods and the foot rod are being folded according to an embodiment of the present invention.

FIG. 3 is a schematic three-dimensional view of a tire table structure wherein the fixing rods are fixed to the desktop unit at the first joint unit with a protrusion fixed into a corresponding fixing hole according to an embodiment of the present invention.

FIG. 4 is a schematic three-dimensional view of a tire table structure wherein the fixing rods, the U shaped rod and the foot rod are being folded according to an embodiment of the present invention.

FIG. 5 is a schematic three-dimensional view of a tire table structure wherein each of the second joint units is being fixed to the U shaped rod with a screw or by welding according to an embodiment of the present invention.

FIG. 6 is a schematic three-dimensional view of a tire table structure wherein the U shaped rod is being rotated away from the fixing rods and forming an included angle to a said fixing rod according to an embodiment of the present invention.

FIG. 7 is a schematic three-dimensional view of a U shaped rod being stretchable at the two feet and contains at least one protrusion and a corresponding fixing hole according to an embodiment of the present invention.

FIG. 8 is a schematic three-dimensional view of a foot rod being a stretchable rod and includes at least one protrusion and a corresponding fixing hole according to an embodiment of the present invention.

FIG. 9 is a schematic three-dimensional view of a foot rod being a stretchable rod and fixed by a screw and thread set according to an embodiment of the present invention.

### DETAILED DESCRIPTION OF THE EMBODIMENTS OF THE INVENTION

Embodiments together with illustrating graphs reference are provided hereafter for further understanding and recognizing of the realization of the present invention.

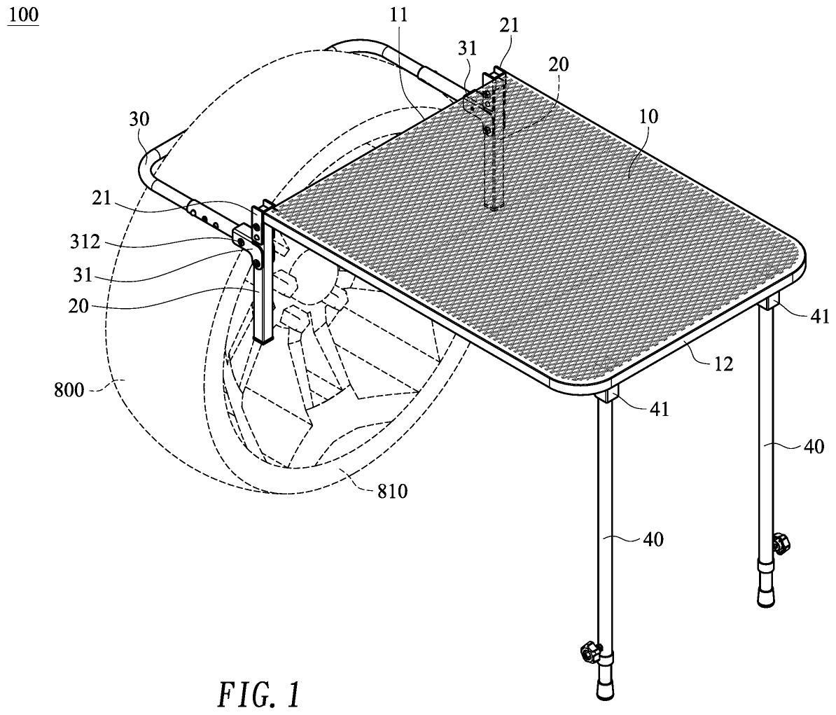

Please refer to FIG. 1, in an embodiment of the present invention, a tire table structure 100 is provided to be used to removably set firmly on a tire 800 of a vehicle, the tire table structure 100 includes a desktop unit 10; two fixing rods 20; an U shaped rod 30; and a foot rod 40.

As can be seen in FIG. 1, the desktop unit 10 of the tire table structure 100, being used to contain at least one objet on, can be a light and firm board, a net or net like body, or plural strip units.

As also shown in FIG. 1, the fixing rods 20, each being connected to a first side 11 of the desktop unit 10 by a first joint unit 21. The number of the fixing rods 20 can be 2, but not necessarily. The forming material of the fixing rods 20 can be any easy to get strong and sturdy materials, such as aluminum, alloy material, or other sturdy materials in the industry.

Referring to FIG. 1, to be firmly set on the tire 800, said tire table structure 100 also includes an U shaped rod 30, the U shaped rod 30 is connected at each end by a second joint unit 31 to one fixing rod 20 in a way that each of the two ends of the U shaped rod 30 being respectively connected by one second joint unit 31 to a different fixing rod 20.

Please refer also to FIG. 1, at least one foot rod 40 is connected to the tire table structure 100, in a way that each foot rod 40 being firmly connected by a third joint unit 41 at a second side 12 of the desktop unit 10.

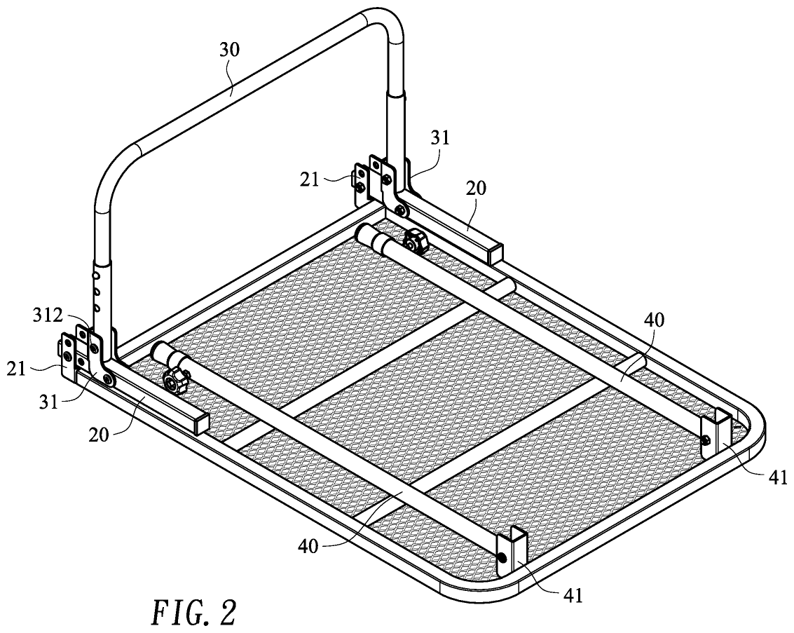

Please refer then to FIG. 1 and FIG. 2, each of the fixing rods 20 of the tire table structure 100 can be folded at the first joint unit 21 and become parallel to the surface of the desktop unit 10, or can be rotated away from the desktop unit 10, firmly fixed at the first joint unit 21 and lean tightly to the outside surface 810 of a tire 800.

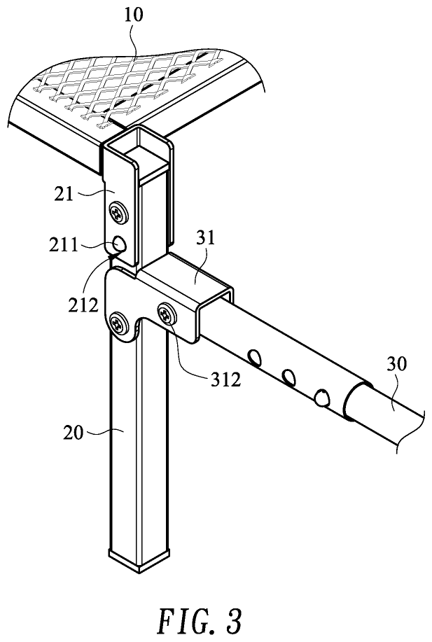

Please refer now to FIG. 1 and FIG. 3, each of the first joint units 21 can include a protrusion 211 and a corresponding fixing hole 212. When using the fixing rods 20 to lean tightly to the outside surface 810 of the tire 800, the fixing rods 20 are rotated away from the desktop unit 10 from the first joint units 21, the protrusion 211 of each fixing rods 20 then fits into the corresponding fixing hole 212 to fix stable the fixing rod 20 at the first joint unit 21 preventing unwanted rotation or movement.

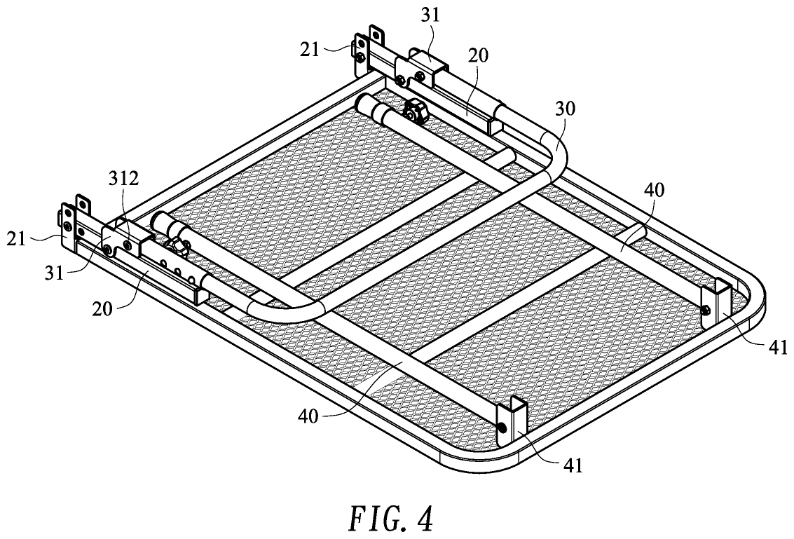

As shown in FIG. 1, FIG. 2 and FIG. 4, the U shaped rod 30 can be folded at the second joint units 31 and become parallel to the fixing rods 20, or can be rotated away from the fixing rods 20 and firmly fixed at the second joint units 31 and fold tightly the tire 800.

That is to say, when the tire table structure 100 is to be used to contain objects on, the U shaped rod 30 is rotated away from the fixing rods 20 and firmly fixed at the second joint units 31 and fold tightly the tire 800; while at the same time, the fixing rods 20 are rotated away from the desktop unit 10 and firmly fixed at the first joint unit 21 and lean tightly to the outside surface 810 of the tire 800.

As such, with the U shaped rod 30 folding tightly the tire 800 and the fixing rods 20 leaning tightly to the outside surface 810 of the tire 800, the tire table structure 100 is firmly and tightly set by the tire 800.

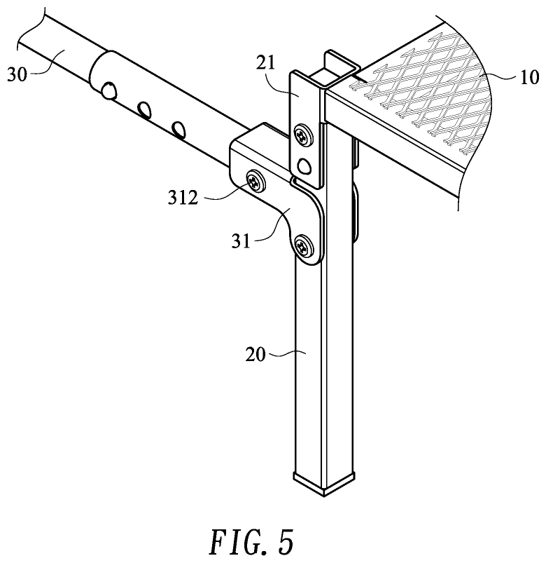

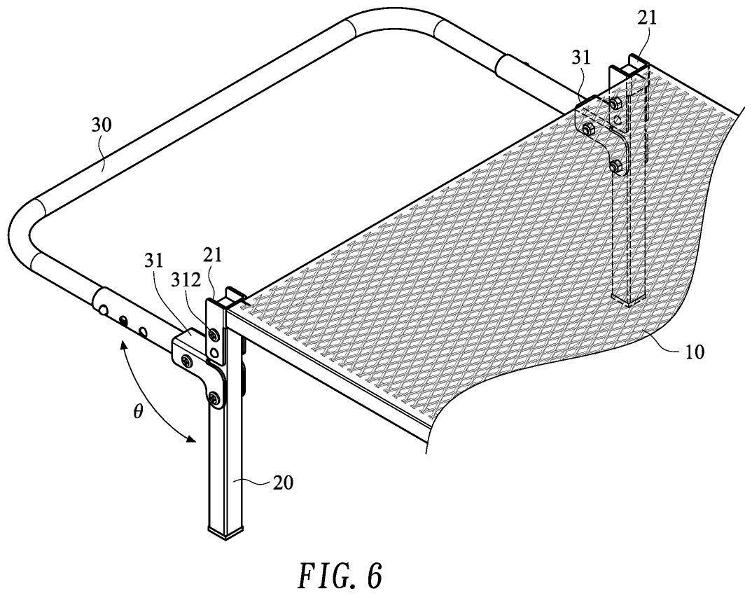

Further, as shown in FIG. 5 and FIG. 6, each of the second joint units 31 can be fixed firmly to the U shaped rod 30 with a screw or by welding. And the U shaped rod 30 can form an included angle θ to a said fixing rod 20 when the U shaped rod 30 is rotated away from the fixing rods 20, the included angle θ is generally 90 degrees or about 90 degrees, which is to say, the included angle θ is 90 degrees±10 degrees (from 80 degrees to 100 degrees).

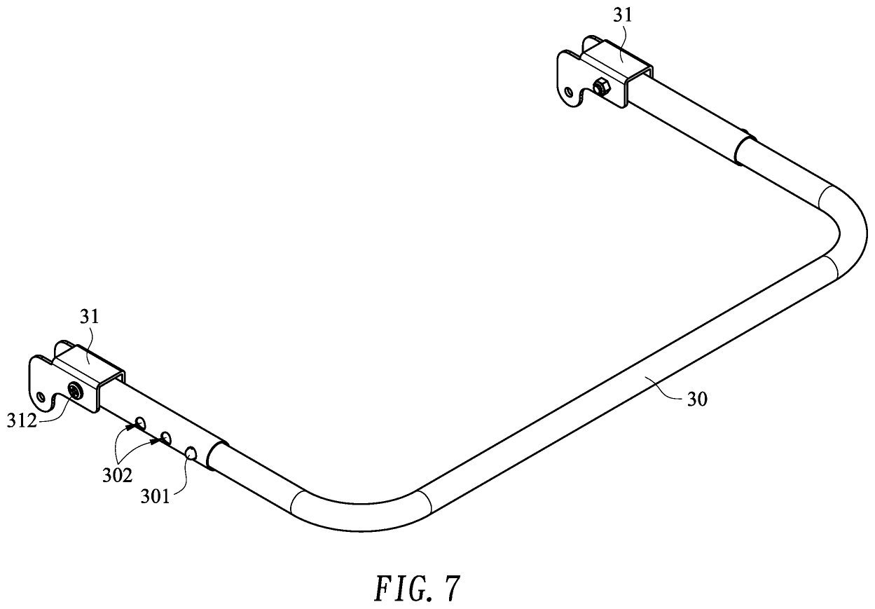

As shown in FIG. 1 and FIG. 7, said U shaped rod 30 of the embodiments can be stretchable at its two feet and contains at least one protrusion 301 and a corresponding fixing hole 302 at each foot.

Being stretchable, the U shaped rod 30 is able to stretch according to the size of the tire 800 to change the size of the encircling space area formed by the U shaped rod 30 and the first side 11 of the desktop unit 10 that the U shaped rod 30 together with the desktop unit 10 can hold tightly the tire 800 no matter what the size of the tire 800 is.

Please refer again to FIG. 1 and FIG. 2, the foot rod 40 of the tire table structure 100 connected at the second side 12 of the desktop unit 10 can be folded at the third joint unit 41 and become parallel to the desktop unit 10, or being rotated away from the desktop unit 10, firmly fixed at the third joint unit 41 and stand firmly on the ground or an object to further ensure the stability when using the tire table structure 100.

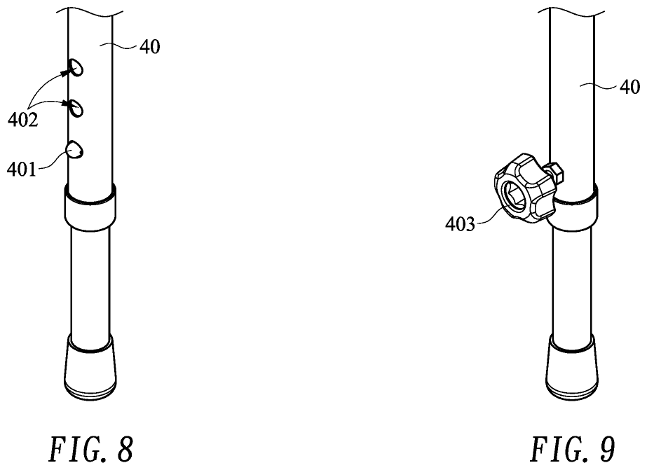

As then shown in FIG. 1, FIG. 8 and FIG. 9, the foot rod 40 can further be a stretchable rod that being folded at the third joint unit 41 and become parallel to the desktop unit 10 or being rotated away from the desktop unit 10 and firmly fixed at the third joint unit 41 and stand firmly on the ground or an object.

As shown in FIG. 8 and FIG. 9, being a stretchable rod in the embodiment, the foot rod 40 can be fixed before or after stretch by a protrusion 401 fit into a corresponding fixing hole 402, or can be fixed before or after stretch by a screw and thread set.

In conclusion, multiple improvements as follows, which cannot be achieved by known existing solutions, can be achieved by the tire table structure 100 in the present invention: Firstly, With the U shaped rod 30 set on and hold the tire 800, the fixing rods 20 firmly fixed at the first joint unit 21 and lean tightly to the outside surface 810 of a tire 800, together with the foot rod 40 firmly fixed at the third joint unit 41 and stand firmly on the ground or an object, the whole tire table structure 100 is firmly set on the tire 800 for various applications. And secondly, before or after applications, the fixing rods 20, the U shaped rod 30 and the foot rod 40 can be folded and set flat next to the desktop unit 10, minimizing the volume for easy storage or transportations.

The embodiments described above are intended only to demonstrate the technical concept and features of the present invention to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

1. A tire table structure, comprising:
a desktop unit, for placing at least one object on;
two fixing rods, each being connected to a first side of the desktop unit by a first joint unit;
an U shaped rod, being connected at each end by a second joint unit to one fixing rod, wherein each of the two ends of the U shaped rod being respectively connected by one second joint unit to a different fixing rod; and
at least one foot rod connected to a second side opposite to the first side of the desktop unit by a third joint unit.

2. The tire table structure according to claim 1, wherein each of the fixing rods is folded at the first joint unit and become parallel to the surface of the desktop unit.

3. The tire table structure according to claim 1, wherein each of the first joint unit includes a protrusion and a fixing hole corresponding to the protrusion.

4. The tire table structure according to claim 1, wherein the U shaped rod is folded at the second joint units and become parallel to the fixing rods.

5. The tire table structure according to claim 1, wherein each of the second joint units is fixed to the U shaped rod with a screw or by welding.

6. The tire table structure according to claim 1, wherein the U shaped rod is rotated away from the fixing rods and forming an included angle to a said fixing rod.

7. The tire table structure according to claim 1, wherein the U shaped rod is stretchable and contains at least one protrusion and a corresponding fixing hole.

8. The tire table structure according to claim 4, wherein the U shaped rod is stretchable and contains at least one protrusion and one corresponding fixing hole.

9. The tire table structure according to claim 6, wherein the U shaped rod is stretchable and contains at least one protrusion and one corresponding fixing hole.

10. The tire table structure according to claim 1, wherein the foot rod is folded at the third joint unit and become parallel to the desktop unit.

11. The tire table structure according to claim 1, wherein the foot rod is a stretchable rod and is folded at the third joint unit and become parallel to the desktop unit.

12. The tire table structure according to claim 11, wherein the stretchable rod is fixed before or after stretch by a protrusion fit into a corresponding fixing hole, or is fixed by a screw and thread set.

13. The tire table structure according to claim 1, wherein each of the fixing rods is rotated away from the desktop unit and fixed at the first joint unit and lean to the outside surface of a tire.
